(19) United States
(12) Patent Application Publication
(10) Pub. No.: US 2010/0209589 A1
(43) Pub. Date: Aug. 19, 2010

(54) Meat Flavoring Compositions and Methods for Making and Using Them

(76) Inventors: Denise GARDNER, Calistoga, CA (US); Sabrina HANNAH, Blacksburg, VA (US); Kevin HOLLAND, Christiansburg, VA (US); Paul SARNOSKI, Blacksburg, VA (US)

Correspondence Address: LATIMER INTELLECTUAL PROPERTY LAW, LLP, P.O. BOX 711200, HERNDON, VA, 20171, US

(21) Appl. No.: 12/708,152

(22) Filed: Feb. 18, 2010

Related U.S. Application Data
(60) Provisional application No. 61/153,803, filed on Feb. 19, 2009.

(51) Int. Cl. A23L 1/22

(52) U.S. Cl. 426/650; 426/509

(57) ABSTRACT

The invention includes compositions and methods that provide savory, spicy, and unique seasoning for cooking meats. In embodiments, a food flavoring composition is provided which comprises one or more flavoring agents and one or more binder together forming a solid composition, wherein the solid composition has a hard candy-like consistency and is shaped to be inserted itself into meat. The invention provides a quick and easy method for spicing meat using spice portions that can be inserted into the meat. The compositions have an extended shelf life compared to liquid marinades or powdered spice rubs. Further benefits of the invention include no mess, no clean up, and a method that adds flavor to meats from the inside out.

### CROSS-REFERENCE TO RELATED APPLICATIONS

This application relies on the disclosure of and claims the benefit of the filing date of U.S. Provisional Application No. 61/153,803, filed Feb. 19, 2009, the disclosure of which is incorporated by reference herein in its entirety.

### BACKGROUND OF THE INVENTION

1. Field of the Invention

The present invention relates to the field of food seasonings and in particular meat flavoring compositions comprising a hard candy-like texture and form for enabling insertion of the flavoring into meats without a tool.

2. Description of the Related Art

A desire exists in the food market for savory, flavorful products including gourmet sauces, marinades, and condiments. Gourmet sauce and condiment sales advanced 12% in 2007, which growth settled the industry at $5.7 billion in sales, and is expected to grow well over $10 billion by 2012. See Porjes, S., Gourmet, Specialty, and Premium Foods and Beverages in the U.S., in 2007 Packaged Facts: Rockville, Md.

Gourmet sauces and marinades give variety and uniqueness to meals, making them more pleasurable for the entire family. The idea that consumers can produce their own gourmet meals quickly and easily is rapidly catching on. See Slater, C., Market Trends: Food Flavors and Ingredients Outlook 2006, in 2006 Packaged Facts: New York, N.Y. An increase in the use of outdoor grilling has also encouraged the use of sauces and marinades for homemade dinners. Today, 8 out of 10 families own an outdoor grill, which shows the prominence of grilled meals for family dinners. See Porjes 2007. In addition, 2008 statistics show that the fresh meat market in the United States accounts for $142.3 billion, and is projected to continue growing. See The Fresh Meat Market in the U.S.: Beef, Chicken, Pork, Turkey, and Lamb in Retail and Foodservice, in 2008 Packaged Facts 2008: Rockville, Md.

Meat flavoring products are available in various forms, including traditional liquid marinades, injectable liquid marinades, and seasoning blend rubs. Liquid-based sauces and marinades are available from numerous companies, including, Kraft (A-1, Bar-b-que sauces, salad dressings, and South Beach Living Dressings); Heinz (Jack Daniels® EZ Marinades); and Sweet Baby Rays Bar-B-Q Sauce to name a few.

Use of traditional liquid marinades generally requires advance planning as flavoring of the meat is achieved through long term exposure of the muscle tissue to the liquid based seasonings for the flavored liquid to penetrate deep into and throughout the meat. Additionally, traditional liquid marinades are messy, usually involving the soiling of additional storage containers for marinating the meat in prior to cooking. Seasonings in liquid form are also not as dense as solid form seasonings and as a consequence are provided and sold in large containers, such as bottles, which generally take up substantial pantry space. Even further, once opened, if not used all at once, liquid marinades have a short shelf life and usually last longer with refrigeration, taking up valuable space in the refrigerator. Refrigerator space is further occupied by the meat and its container during the marinade process, as it is typically recommended to refrigerate the meat while it is marinating usually for hours in a liquid-type seasoning.

Injectable liquid marinades are similar to traditional liquid marinades but are sold with a syringe that allows the consumer to inject the marinade directly into the meat product. Syringes may require additional prep time for filling the syringe instrument, injecting the flavoring into the meat, and cleaning of the syringe. Disposable syringes are disadvantageous in that they are not environmentally friendly and once used are discarded as waste is generated. Syringe-type seasonings can be difficult to use and can be messy during administering of the liquid seasoning to the meat, especially if the liquid seeps out of the syringe at unexpected times.

Seasoning rubs for meats are also available to consumers. Rubs, however, typically call for extensive handling of the meat product to ensure the flavoring is evenly distributed on the product. Additionally, rubs provide a flavor sensation limited to the surface or just under the surface of the meat. Even if allowed to contact the surface of the meat for a substantial period of time prior to cooking, rub-type versions of seasonings are incapable of penetrating deep within the meat to provide consistent flavor throughout the meat. Rubs can be hazardous to the consumer as well, in that when grilling, rub-type flavorings on the surface of the meat can contribute, cause, or facilitate charring of the meat during cooking, or even cause flames to be generated from the surface of the meat making grilling a dangerous experience for the one grilling. Charring, though it may be appreciated by some consumers, may be an undesirable result for others, especially younger consumers, such as children.

Solid form seasonings also exist. Probably the most well known seasoning of the solid-form class is the bouillon cube, which is typically formed by way of a dehydration and/or compression process. Bouillon is typically not used to provide flavoring for meats, but rather is dissolved in boiling liquids to flavor soups. In any case, such cubes lack sufficient hardness and a shape (such as a form having an edge, knife-like, or otherwise utensil-like shape), the combination of which renders the seasoning form itself capable of being inserted into meat. Without an assisting tool, such as a knife, to first drill a pilot hole into the flesh of the meat, bouillon cubes would not be capable of being inserted deeply into the meat. Further, even if bouillon cubes were somehow inserted into meat, the flavoring would not be sufficiently distributed throughout the meat due to the size of the cubes. As a result, the cooked meat product would not be aesthetically pleasing to the consumer due to the large voids left behind in the meat after the cube dissolves, and the final product would not have a consistent flavor throughout the meat, i.e., the consumer would experience intense flavor in portions of the meat that contacted the bouillon during cooking and perhaps no added flavor in other portions of the meat.

Other seasoning forms exist as well, including the type disclosed, for example, in U.S. Pat. No. 7,169,433, entitled “Seasoning Stick and Method and Apparatus for Preparing Foods,” the disclosure of which is incorporated by reference herein in its entirety. In particular, a seasoning stick or other solid form is disclosed that is composed of a binder matrix holding a seasoning or mixture of seasonings. The rigidity of the composition is due to the combination of the particular binder used and the process of manufacture (compression or extrusion). Basically, the binder and seasoning are mixed in particulate form and pressed together mechanically, not chemically, to achieve suspension of the seasoning in a solid matrix. The binder (a copolymer of ethylene oxide and propylene oxide, selected according to melting point temperature) then disintegrates during heating (between 100-140° F.) of the food to release the seasoning.

U.S. Pat. No. 6,692,783, entitled “Method and Apparatus for Internally Seasoning Meat Prior to and During Cooking,” the disclosure of which is incorporated by reference herein in its entirety, provides a seasoning rod filled with flavoring agents, inserted into meat, and then removed from the meat after cooking. Disadvantages of such products include having to fill the rod with flavoring agents, and then remove the rod prior to consuming the food, and cleaning the rod for future use. Food prepared in this manner tends not to have maximum or consistent flavor throughout the meat, as only one rod is typically used instead of several smaller flavoring spikes.

In light of the above-described issues with existing meat flavorings and seasonings, what is needed is an efficient, easy to use, flavorful, non-messy, convenient, effective, deep penetrating seasoning for meats.

### SUMMARY OF THE INVENTION

Unlike other commonplace marinades and seasonings, embodiments of the present invention, including Spice n Easy™, provide delicious flavoring to a variety of meats in a mess-free, quick and easy manner.

Embodiments of the invention include Spice n Easy™ spikes, a gourmet seasoning, perfect for roasting and grilling meat products. It acts as flavor enhancers like a typical meat marinade, with a convenient, no-mess twist. Spice n Easy™ is capable of satisfying gourmet consumers looking for a fancy flare to add to a meal, or even active families who need a quick, convenient, and tasty product for dinner.

Another potential for the product is in the large-scale food preparation industry. For example, it is suspected that formulators of frozen cuisine, especially with respect to ready-to-go frozen family size meals, would also be interested in using the inventive spice sticks directly in meals sold uncooked and frozen directly to the consumer. By inserting the seasoning sticks into meat or other food products, manufacturers can “formulate” delicious recipes without using valuable time and resources waiting for foods to marinate prior to freezing and packaging them for the consumer.

TABLE 1
Spice n Easy ™ vs. Competing Seasoning Products

| | Traditional | Injectable | | |
|---|---|---|---|---|
| | Liquid | Liquid | Seasoning | Spice n |
| | Marinade | Marinade | Rubs | Easy ™ |
| Does Not Require Pre- | No | Yes | Yes | Yes |
| cooking Exposure Time | | | | |
| Does Not Generate Extra | No | No | Yes | Yes |
| Mess, Dishes, or Waste | | | | |
| Provides Flavor | Yes (time | Yes | No | Yes |
| Throughout the Meat | dependent) | | | |

Seasoning embodiments include, a food flavoring composition comprising one or more flavoring agents and one or more binder together forming a solid composition, wherein the solid composition is prepared from solidified liquid matter.

Objects of the present further provide a food flavoring composition comprising one or more flavoring agents and one or more binder together forming a solid composition, wherein the binder is not one of ethylene oxide (EO), propylene oxide (PO), or a co-polymer of ethylene oxide and propylene oxide.

Still further, a food flavoring composition comprising one or more flavoring agents and one or more binder together forming a solid composition, wherein the solid composition has a hard candy-like consistency and is shaped to be inserted itself into meat is also considered within the scope of the invention.

Preferred are compositions described herein comprising an amount of binder ranging from about 50-99% by weight of the composition, or in an amount ranging from about 80-90% by weight of the composition.

Compositions mentioned herein comprising a hard candy-like consistency are especially preferred. Additionally, solid compositions prepared using chemistry instead of by mechanical means or techniques are especially preferred, which generally have a harder solid structure in comparison.

Compositions having an amorphous or quasi-crystalline structure are included within embodiments of the invention.

Further preferred are compositions of the invention which comprise as binder a sugar. An especially preferred binder is sucrose.

The seasonings (also referred to as spices or flavoring agents) can be in any form, including powdered, liquid, flake, granular, crystalline, loose leaf, seed or seed-like, berry or berry-like form. Preferred are compositions comprising seasonings in a non-powdered form.

Also included in embodiments of the invention are method of preparing a food seasoning product comprising: mixing water and one or more binder to form a liquid matrix composition; heating the composition for a time and up to a temperature sufficient to bring the liquid matrix composition up to a hard-crack stage; adding one or more flavoring agent to the liquid matrix composition to form a seasoning-containing composition; cooling the seasoning-containing composition to form a solid composition with a hard candy-like consistency and a shape to enable insertion of the solid itself into meat. Optionally, the cooling is performed on a marble slab to ensure rapid cooling. Methods of the invention can be performed by in any order or combination. Further, not all method steps must be performed for each batch. For example, in the method provided just above, the composition can be heated before or after addition of the spices. Likewise, mixing or stirring of the composition can take place during heating whether before, after, or during heating.

Preferred is a food seasoning product formed using any method described herein, especially those described immediately above and just below.

Food products comprising any of the compositions described herein are further included within the scope of the invention, such as pre-prepared meals to be sold to consumers, such as frozen cuisine.

### BRIEF DESCRIPTION OF THE DRAWINGS

FIG. 1 is a photo showing a representative embodiment of Spice n Easy™ in comparison with a traditional spice product.

FIG. 2 is a flowchart showing a representative manner in which embodiments of the invention can be manufactured.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

Embodiments of the invention include seasoning compositions, especially relevant to preparing meats, that comprise one or more seasoning suspended in a solid binder matrix. Preferred embodiments of the invention include compositions comprising seasoning and binder material, wherein the seasoning becomes bound within the composition during solidification of a binder solution. In embodiments, the composition (seasoning and binder) is a solid formed from a liquid. Such compositions can be prepared in a manner wherein a chemical reaction takes place during manufacturing, which contributes to the hardness characteristics of the final solid form. More particularly, and preferably, the binder is dissolved (chemical reaction) in a liquid (and seasonings added) and the resulting solution is heated to a temperature sufficient to alter the characteristics of the solution, i.e., dehydrated, and/or, crystallized, and/or condensed (chemical reaction) into a syrup. Such compositions are said to be chemically-formed compositions, as opposed to mechanically-formed compositions.

Other embodiments include preparing the seasoning compositions mechanically. For example, the binder (typically sugar) and the seasoning can be mixed and then pressed together under substantial pressure to cause melting of the binder enough to suspend the seasoning in the binder when pressure is released.

In preferred embodiments, however, the solution (typically at least a binder, water, and seasoning) is heated to a point where the material being heated is allowed to reach the hard-crack stage. To reach the hard-crack stage, typically a solution is heated to a temperature that would yield a hard consistency upon cooling. This temperature would preferably be between about 300-310° F., for example as determined by a candy thermometer. A simple test that can be performed to determine whether the hard-crack stage was reached is to remove a sample (drop) of the resulting syrup and add it to cold water. The solution (now a syrup) has reached the hard-crack stage if the drop of syrup forms hard, brittle threads as it passes through the cold water.

Using the syrup at this stage (in combination with rapid cooling of the syrup) to form solid pieces of the composition having seasoning suspended therein and therethrough, will result in seasoning compositions having a hardness capable of withstanding normal kitchen handling and capable of being inserted into meat, or other tough textured food products, without crumbling and without tool-assisted means.

The solid form composition has a definite shape and volume. The chemical structure of the solid composition can be crystalline, amorphous, or quasi-crystalline in nature, depending on the degree of order in the arrangement of the atoms. Preferred embodiments comprise seasoning compositions in amorphous (glass-like) form and/or in totally or partially crystalline form.

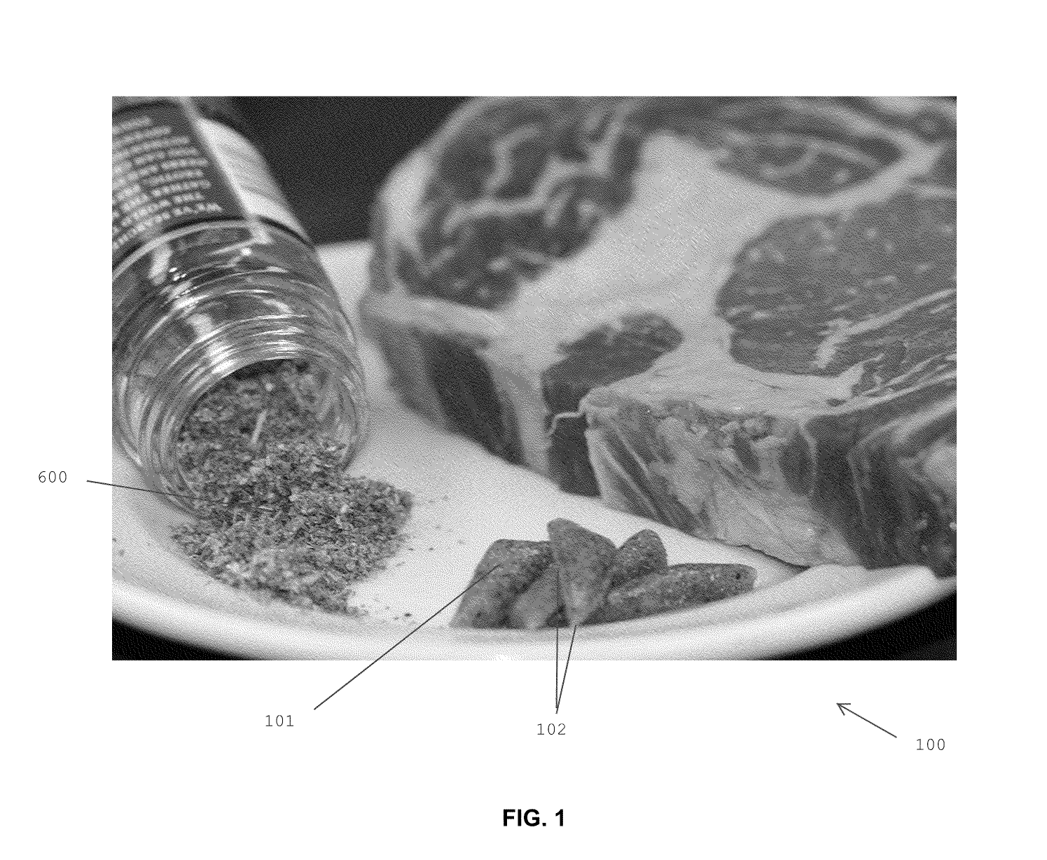

FIG. 1 is a photo showing a representative embodiment of Spice n Easy™ in comparison with a traditional typical powdered spice rub. As shown, embodiments of the invention include spice sticks 100, which comprise a hard candy-like consistency and are shaped to enable insertion of the stick 100 into a piece of meat. In contrast, a typical powdered spice rub 600 is also shown, which would typically be applied by rubbing the powder on the outer surface of a piece of meat to provide a coating of a spice or spice mix.

More particularly, spice sticks 100 comprise a hard outer surface 101. As shown in this embodiment, the outer surface 101 has a texture that appears glassy, much like the outer surface of a piece of hard candy. Seasoning sticks 100 comprise a shape or form that is conducive to allowing the sticks 100 to be easily inserted into a piece of meat. In combination with having a shape that enables insertion into the meat, a smooth, glassy texture of the outer surface 101 further contributes to ease of insertion by reducing friction that may be caused during insertion where the outer surface 101 contacts the meat tissue.

The exact shape of the seasoning “sticks” is not critical, and as shown the flavoring compositions can comprise one or more edge 102, which facilitates cutting of the meat tissue by the edge itself. A triangular-type form is exemplified in FIG. 1, however, unlimited alternative shapes are equally acceptable. Variations include wedge, peg, stick, rod, thread, band, bead, pellet, ribbon, cone, spike, spear, skewer, toothpick, razorblade, pyramid, football, needle, knife, square, rectangular, and disk forms to name a few. Thin rectangular, circular, triangular, square etc. disk-like structures with beveled edges 102 are also within the scope of the invention, as well as elongated (rod-like) forms. Generally, the harder the consistency of the composition, the cutting capabilities of the edges, points, or spears need not be emphasized. Likewise, for softer compositions a sharp edge or point on the composition would facilitate insertion of the solid form into the meat or other food article without breaking.

Likewise, the invention is not limited to only solid forms. For example, the hard candy-like structure can also comprise a hollow cylinder shape. While such a shape may be appropriate for some applications, such a shape may be too fragile, e.g., a hollow cylinder form may work especially well for inserting flavoring into fish, but might not be capable of being inserted into a tougher type of muscle tissue, such as beef. Even further, the inventive spice product can take the form of having a hard out shell with a hardness and shape rendering it capable of penetrating the muscle tissue of a piece of meat, and yet a softer solid interior, a soft candy-like center (e.g., taffy), or even a liquid center. In such embodiments, the center or interior (portion of product surrounded or encapsulated by the outer shell) can be a different composition, but in preferred embodiments the inside is also formed from binder, water, and seasoning.

The composition of the seasoning product according to embodiments of the invention comprises a binder in a concentration ranging from about 75%-95% by weight, such as for example about 80-85%, 85-90%, and 80-90%. Indeed any percentage from 50-99% binder is feasible and would provide a range of hardness needed to accommodate various types of meats, from softer tissue vegetables like green peppers and meats like fish, shellfish, and chicken to tougher tissue vegetables like potatoes or carrots and meats, such as pork and beef.

The binder acts to hold (e.g., suspend) the seasonings in a solid matrix. One way to achieve this goal is by putting the binder into solution or a liquid based suspension, for example by dissolving any sugar in water. Preferred embodiments use sucrose as a binder, but other suitable sugars or carbohydrates could be used, including but not limited to fructose, high fructose corn syrup, molasses, maltodextrins, dextrose, maltose, corn syrup, or other sugars. The sucrose concentration should be sufficient to bind the spices to produce a hard edge for insertion into meats. Concentration of the sucrose should be greater than 60% by weight, and can be as high as 95%. Performance during use is improved if the concentration of sucrose is greater than 70% by weight. The preferred sucrose concentration is 80 to 90% by weight. In addition to binding the spices, the sucrose acts as a flavoring and in some cases as a natural preservative.

Indeed any binder may be used so long as the final product achieves a particular hardness needed for a certain application. Selection of binder(s) for a particular application involves consideration of various factors, including melting temperature, a likelihood of dissolving or being suspended in the liquid solvent, and desired hardness capabilities of the final product. It is possible various gums and thickeners (i.e., xanthan, guar, etc.) could be used as binders, however, such binders may be better suited for meats and vegetables at the lower end of the hardness spectrum. It is preferred from a labeling standpoint that natural binders instead of synthetic binders are used.

Additional factors should also be considered, such as the time taken to cool the composition, which can alter the hardness of the final state and affect the product quality. If cooled slowly, most compositions will have a tendency to be softer than if cooled quickly. A marble slab for cooling the compositions has been found to ensure a most desirable quick cooling time.

Preferably, the binder is selected such that the spices held in the solid matrix are protected from oxidation. This is achieved with sugar as a binder, which forms a hard outside surface or shell that allows oxygen to only contact the outside of the product. Reducing the potential for oxidation to occur renders the product more stable over time and allows the spices to retain their original flavor and not degrade over time from exposure to oxygen.

The seasoning compositions according to the invention can be prepared in any typical food processing manner, including by dehydration, compression, extrusion, molding, cooling, freezing, or by the preferred hard candy making method.

The spices can be in any form prior to combination with the binder. Powder, liquid, flakes, granules, crystals, loose leaf, seeds, berries, etc. are all acceptable forms for the seasoning elements of the inventive compositions. After insertion into a meat, the meat is cooked and the temperature of the grilling, baking, etc. causes the binder to decompose, usually by dissolving during cooking. Once the binder has lost its hard form, the spices or other flavorings are freed from the solid matrix and allowed to penetrate, be absorbed into, or adsorbed into the meat thereby infusing the meat with the desired flavor or combination of flavors.

In embodiments of the invention, it is also possible to use different flavor seasoning compositions in a single piece of meat. For example, often when cooking for a family some family members may prefer a Cajun-style meat while others would prefer an Italian-style meat. With liquid marinades, however, a single piece of meat would have to be cut into smaller segments so that individual smaller meat pieces could be marinated separately with different flavor liquid marinades. Cutting the meat into smaller pieces may have an undesirable effect on the texture of the meat upon cooking as the smaller segments of meat would cook faster and perhaps be tougher than compared to a single larger piece of meat. With embodiments of the invention, it is possible to cater to each individual's taste while preparing the food according to the recommended procedure. For example, Italian spice spikes of the invention could be inserted at one end and BBQ flavor spice sticks of the invention could be inserted at the other end of the same piece of meat.

While a virtually infinite number of recipes could be used to vary the spice content of the spice sticks, and therefore the flavor outcome, several examples are now provided. These will give examples of how the invention can be practiced, but do not limit the spices used in making Spice n Easy™ spice sticks.

### Example 1

TABLE 2
Three-Spice Sticks (Cajun Blend) with 81% wt/wt Sucrose Binder

| | |
|---|---|
| 210 | g sucrose |
| 15 | g MSG |
| 15 | g garlic powder |
| 10 | g onion powder |
| 9 | g cayenne |

Mix water and sucrose and heat to 300° F.
Add spices.
Cool and shape.

Spice n Easy™ compositions were made using small batch processing. The sucrose and spices were purchased in a local grocery store. Batches were based on 210 g of sucrose. Water was added and the mixture was brought to about 300° F., within the temperature range usually resulting in the hard crack stage. It is not critical to add a precise amount of water. Preferably, sufficient water is added to dissolve the sugar binder. The rate at which the sugar will dissolve may depend on several factors, including temperature of the room, temperature of the water and the sugar, the type of sugar being added, and the form of sugar to name a few. For example, using sugar cubes and cold water may benefit from a higher content of water than if using granulated sugar and warm water. To obtain a quasi-amorphous product, it may be desirable to leave some of the sugar undissolved. At this point the mixture was taken off of the stove and the previously weighed spices were added. The spices were stirred in to achieve homogeneity and the mixture was poured onto a cool slab of marble to facilitate fast cooling. The cooled mixture was then cut to the desired size and shape using pizza cutters. The Spice n Easy™ compositions are of sufficient hardness and density to be inserted into meat, as an alternative to liquid marinade or coatings of powdered spice rub. The meat is then cooked using any traditional recipe that would ordinarily be used after use of a liquid marinade or powdered spice rub.

### Example 2

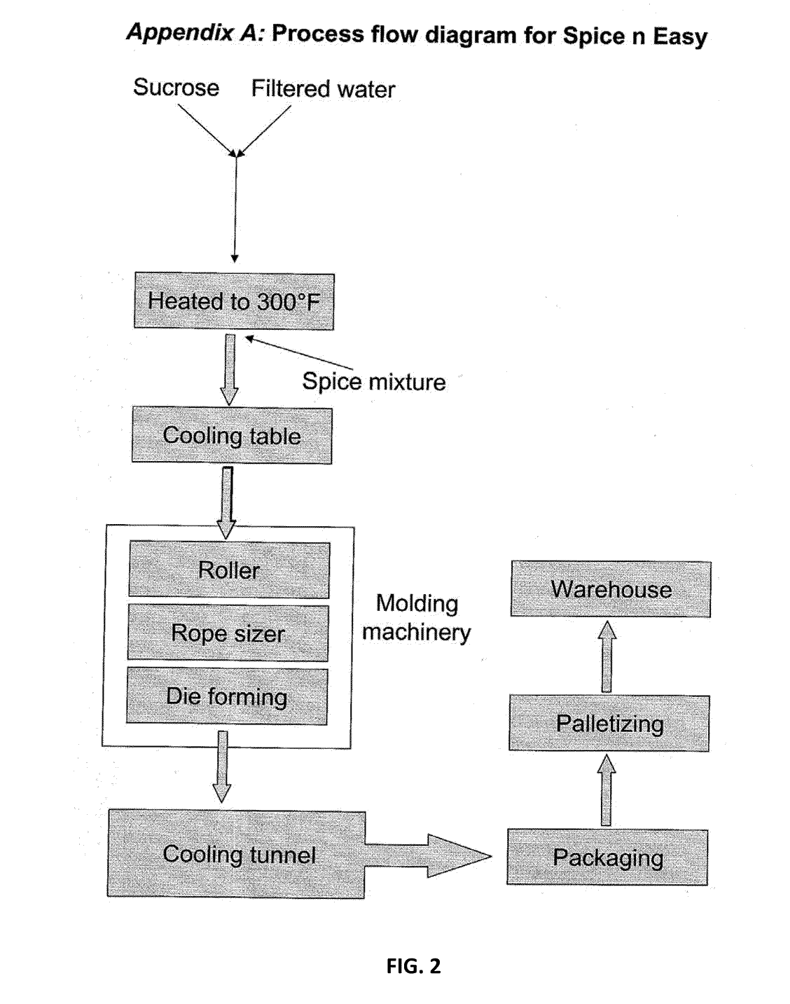

On a commercial scale the process is similar, but equipment is larger and automated. FIG. 2 is a flowchart showing a representative manner in which embodiments of the invention can be manufactured according to a commercial process. Preferred processes according to the invention include combining a carbohydrate and water, heating the combination to a temperature capable of producing a hard candy consistency, and cooling the candy. During the cooling phase, the composition can optionally be molded into any desired form.

As shown in FIG. 2, batch processing and continuous operation can be used to lower initial capital. The sucrose and spices can be received and stored at the factory dry. Sucrose and filtered water can be mixed together in a large kettle and then heated to about 300° F. Throughout this disclosure, when referring to the binder in water, or the binder matrix, it is intended to encompass any form of the combination that results from the addition of the binder to the water in the given situation. For example, the invention includes where the liquid composition (combination of binder and water) is a solution or a mixture or a quasi-solution. The solids do not have to be fully dissolved. For some applications, however, it may be desirable to have a solution. The same applies when referring to the liquid composition even after the addition of other components, such as the seasoning, the resulting liquid-based composition can be a mixture, a solution, or a combination of the two. Additives to combat foaming and crystallization, such as butter and/or corn syrup (such as Karo syrup), can optionally be added to the mixture (or to any such mixture in any of the composition examples disclosed herein). For example, 100 g of sugar, 30 g of butter, and 50 g Karo syrup can be added to water, typically before addition of the spices. It is recognized that the Karo syrup in this situation would function doubly as a binder, and so its weight should also be considered when determining the anticipated desired level of total binder in the final product. Additionally, combinations of different binders can be used, such as using granulated white sugar with a portion of binder being corn syrup or brown sugar with molasses, any combination of sugars is feasible, the choices are limitless. Then the desired spices can be added in any desired amount. The mixture is then blended.

The mixture is transferred to a cooling table to reach the desired consistency, and then moved to a molding machine. This process can utilize a roller and rope sizer to achieve the necessary rope size for the die forming machine. A typical die forming machine can form individual spikes at a rate of approximately 1000 per minute. See http://www.keychoc.com/products_hardcandy_forming.htm#, cited 10 Feb. 2009, Keychoc, “Hard Candy Forming Machine.”

Cut and shaped pieces can move through a cooling tunnel to allow the product to harden. After cooling, Spice n Easy™ spikes can be packaged by weight in a multilayer polymer pouch incorporating a barrier film to inhibit oxygen transmission. One type of packaging suitable for this application would be a low-density polyethylene (LDPE) interior for sealing properties, a poly(vinylidene chloride) (PVdC) oxygen barrier layer in the middle, and a polypropylene (PP) outer layer for printing. Other suitable packaging is well-known to those of ordinary skill in the art, and could also be used for this purpose. The pouches can be placed in secondary packaging, loaded into cases, palletized, and sent to a cool, dry warehouse to await shipping.

### Example 3

TABLE 3
Five-Spice Sticks with 86% wt/wt Sucrose Binder

| | |
|---|---|
| 210 | g sucrose |
| 15 | g garlic powder |
| 6 | g oregano |
| 2 | g rosemary |
| 8 | g crushed red pepper flakes |
| 2 | g parsley |

Mix water and sucrose and heat to 300° F.
Add spices.
Cool and shape.

Spice n Easy™ compositions containing the five spices above were prepared according to the methods described in Example 1 above.

### Example 4

Spice n Easy™ flavoring compositions were made according to the recipe of Example 1 or Example 3. Prototype batches were based on 210 g of sucrose. Water was added and the mixture was brought to 300° F. The mixture was taken off of the stove and the previously weighed spices were added. Cornstarch was used to form molds that resulted in various shapes and sizes of Spice n Easy™ spice sticks. Having cornstarch as a coating on the final products also helps deter the potential for the individual spikes to stick to one another during storage once packaged. In some of the batches, various gums and thickeners (e.g., xanthan, guar, etc.) were added to modify the hardness of the final composition from batch to batch.

### Example 5

TABLE 4
BBQ Flavored Spice Sticks with 81% wt/wt Sucrose Binder

| | |
|---|---|
| 210 | g sucrose (or any sugar) |
| 9 | g garlic powder |
| 4.5 | g onion powder |
| 4 | g chili powder |
| 10 | g smoked sea salt |
| 22 | g tomato paste |

Mix water and sucrose and heat to 300° F.
Add spices.
Cool and shape.

### Example 6

TABLE 4
Italian Seasoning Spice Sticks with 89% wt/wt Sucrose Binder

| | |
|---|---|
| 210 | g sucrose (or any sugar) |
| 6 | g oregano |
| 2 | g rosemary |
| 2 | g parsley |
| 15 | g garlic powder |

Mix water and sucrose and heat to 300° F.
Add spices.
Cool and shape.

Spice n Easy™ spikes are a unique way to add flavor to meat products without the wait and mess of a marinade. The spikes are easily inserted in the meat prior to cooking and there is no waiting time. During the cooking process, the spikes completely dissolve releasing their flavor. Spice n Easy™ can be used to roast, grill, and/or slow-cook any food item, including vegetables such as potatoes; meat such as chicken, beef, fish, and pork; or breads, including pizza crust to name a few.

Spice n Easy™ spice stick spikes can be formulated to contain all natural ingredients—premium spices expertly blended to enhance meat flavor in a sucrose-based matrix. Spice n Easy™ requires no additional tools for use and creates little waste. Spice n Easy™ embodiments do not need to be refrigerated and have a long shelf life. Each pouch of flavoring compositions contains enough spikes to season two pounds of meat. The consumer can easily vary the level of flavoring added to the meat and save the remaining Spice n Easy™ spikes for another meal.

In preferred embodiments, Spice n Easy™ has a shelf life of about one year or more. The main concerns for shelf life of Spice n Easy™ are moisture absorption and flavor loss due to spice oxidation. Spice n Easy™ has a water activity of 0.24 indicating no concerns of microbial growth. Water activity below 0.25 is sufficient to enable maximum shelf life of unpacked hard candy. See Handbook of Food Preservation. Second edition ed, ed. M. S. Rahman. 2007, New York, N.Y.: CRC Press.

The sucrose also protects any spices not on the surface from oxidation and flavor degradation. Dry spices can be added to the sucrose in a powdered, crumbled, or crushed form. In some cases, fresh spices could also be used, but it is preferred that the spices are dry or dessicated so that the water activity remains below 0.25. Spices are mostly contained in the interior of the product, which exists in a stable glassy state. Flavor degradation will be slower in this product relative to traditionally packaged spices. Additionally, packaging described previously prevents moisture absorption and aid in preventing surface spice oxidation. Current Good Manufacturing Practices (GMPs) should be adhered to during all stages of Spice n Easy™ production to ensure product safety. Raw material safety should be ensured by suppliers. Spices can be sourced from American Spice Trade Association (ASTA) member companies to ensure that suppliers are following GMPs.

Certain embodiments of Spice n Easy™ are capable of infusing seasoning through the entire thickness of a piece of meat without using a utensil to drill a pilot hole in the meat. This is achieved through the hardness of the seasoning composition, the shape of the composition, and in particular the types of edges of the compositions, which together contribute to render the composition itself an instrument or tool for cutting into the tissue of the meat to bring the seasoning where it is needed most, below the outer surface of the meat and deep into the center.

The compositions according to the invention can be preservative free or have a reduced amount of preservatives that consumers do not value in products. Binders such as ethylene oxide or propylene oxide, although they can be used in compositions of the invention, may also be omitted. Propylene oxide is a known anti-microbial and/or preservative. Ethylene oxide is commonly added to food products as a fumigant. Fumigants are used to prevent pest infestations in food. The food product may be negatively impacted by the preservative (such as methyl bromide, ethylene dibromide, ethylene dichloride, carbon tetrachloride, phosphine and ethylene oxide), especially over time during storage, as residues of unchanged fumigant may remain in the food and react with chemical components of the food, thereby altering the chemical or physical properties of the product and resulting in changes in flavor, taste, odor, nutritional value or processing qualities of the product. See, for example, Jack R. Plimmer, “The Effect of Fumigants on Food Quality,” Journal of Food Safety, Vol. 1, Issue 2, pp. 87-105, published on-line Apr. 3, 2007, the disclosure of which is hereby incorporated by reference in its entirety.

Spice n Easy™ can be resealed in the original packaging and stored for up to one year without refrigeration. Embodiments of the invention can be provided in environmentally-friendly packaging, such as in a biodegradable paper-based product, unlike the typical glass containers for salad dressings or plastic syringes for injectable-type liquid marinades, which require a further recycling step to be “green.”

Spice n Easy™ is easier and cleaner than traditional meat marinade products and seasoning rubs. Use of marinades generally requires advance planning as flavoring is achieved through long term exposure of the muscle tissue to the liquid based seasonings. Traditional marinades create more mess and consume more pantry space than Spice n Easy™. Once opened, if not used all at once, liquid marinades have a short shelf life. Spice n Easy™ can be resealed in the original packaging and stored for up to one year. Spice n Easy™ does not require valuable refrigerator space like liquid marinades. Injectable liquid marinades are similar to traditional liquid marinades but are sold with a syringe that allows the consumer to inject the marinade directly into the meat product. The syringe can be difficult and messy to use. Seasoning rubs require more handling of the meat product than Spice n Easy™ and only produce flavor on the surface of the meat. The flavors in Spice n Easy™ are better preserved during storage than seasoning rubs due to the glassy state of the product. Also, there is no concern over caking as often occurs in seasoning blends during storage. Flavoring would be better distributed throughout the food product using Spice n Easy™ as several small spikes are inserted throughout the meat.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

1. A food flavoring composition comprising one or more flavoring agents and one or more binder together forming a solid composition, wherein the solid composition is prepared from solidified liquid matter.

2. A food flavoring composition comprising one or more flavoring agents and one or more binder together forming a hard candy-like solid composition, wherein the binder is not one of ethylene oxide (E0), propylene oxide (PO), or a co-polymer of ethylene oxide and propylene oxide.

3. A food flavoring composition comprising one or more flavoring agents and one or more binder together forming a solid composition, wherein the solid composition has a hard candy-like consistency and is shaped to be inserted itself into meat.

4. The composition of claim 1 comprising binder in an amount ranging from about 50-99% by weight of the composition.

5. The composition of claim 1 comprising binder in an amount ranging from about 80-90% by weight of the composition.

6. The composition of claim 1 comprising a hard candy-like consistency.

7. The composition of claim 3, wherein the solid composition is not formed from mechanically-induced pressure exerted on solid binder and flavoring agent particles to activate the binder into binding the flavoring agent within a binder matrix.

8. The composition of claim 1, wherein the solid composition has an amorphous or quasi-crystalline structure.

9. The composition of claim 1, wherein the binder is a sugar.

10. The composition of claim 1, wherein the binder is sucrose.

11. The composition of claim 1, wherein the flavoring agent is in powdered, liquid, flake, granular, crystalline, loose leaf, seed or seed-like, berry or berry-like form.

12. The composition of claim 11, wherein the flavoring agent is in liquid, flake, granular, crystalline, loose leaf, seed or seed-like, berry or berry-like form.

13. A method of preparing a food seasoning product comprising:
mixing water and one or more binder to form a liquid matrix composition;
heating the composition for a time and up to a temperature sufficient to bring the liquid matrix composition up to a hard-crack stage;
adding one or more flavoring agent to the liquid matrix composition to form a seasoning-containing composition;
cooling the seasoning-containing composition to form a solid composition with a hard candy-like consistency and a shape to enable insertion of the solid itself into meat.

14. A food seasoning product formed using the method of claim 13.

15. The method of claim 13, wherein the cooling is performed on a marble slab to ensure rapid cooling.

16. A food comprising the composition of claim 1.

17. A food comprising the composition of claim 2.

18. A food comprising the composition of claim 3.
